(19) United States
(12) Patent Application Publication
(10) Pub. No.: US 2004/0154647 A1
(43) Pub. Date: Aug. 12, 2004

(54) Method and apparatus of utilizing a coating for enhanced holding of a semiconductor substrate during high pressure processing

(75) Inventors: Alexei Sheydayi, Gilbert, AZ (US); Joe Hillman, Scottsdale, AZ (US)

Correspondence Address: Thomas B. Haverstock, HAVERSTOCK & OWENS LLP, 162 North Wolfe Road, Sunnyvale, CA, 94086, US

(73) Assignee: Supercritical Systems, Inc.

(21) Appl. No.: 10/359,965

(22) Filed: Feb. 7, 2003

(51) Int. Cl. B08B 5/04

(52) U.S. Cl. 134/21

(57) ABSTRACT

A vacuum chuck for holding a semiconductor wafer during supercritical processing comprising: a substantially smooth wafer holding region for holding the semiconductor wafer; a vacuum port for applying vacuum to a portion of the wafer holding region; and a material applied between the semiconductor wafer and the wafer holding region, the material being conformable to provide substantially intimate contact between the surface of the semiconductor wafer and the wafer holding region. The material is preferably a polymer, monomer or any other suitable material is contemplated. The vacuum chuck further comprising a vacuum region configured within the wafer holding region, wherein the vacuum region is coupled to the vacuum port.

### FIELD OF THE INVENTION

This invention relates to the field of high pressure processing. More particularly, this invention relates to a method and apparatus of utilizing a coating for enhanced holding of a semiconductor substrate during high pressure processing.

### BACKGROUND OF THE INVENTION

Processing of semiconductor substrates or wafers presents unique problems not associated with processing of other workpieces. Typically, the semiconductor processing begins with a silicon wafer. The semiconductor processing starts with doping of the silicon wafer to produce transistors. Next, the semiconductor processing continues with deposition of metal and dielectric layers interspersed with etching of lines and vias to produce transistor contacts and interconnect structures. Ultimately in semiconductor processing, the transistors, the transistor contacts, and the interconnects form integrated circuits.

A critical processing requirement for the processing of the semiconductor wafer is cleanliness. Much of semiconductor processing takes place in vacuum, which is an inherently clean environment. Other semiconductor processing takes place in a wet process at atmospheric pressure, which because of a rinsing nature of the wet process is an inherently clean process. For example, removal of photoresist and photoresist residue subsequent to etching of the lines and the vias uses plasma ashing, a vacuum process, followed by stripping in a stripper bath, a wet process.

Other critical processing requirements for the processing of the semiconductor wafers include throughput and reliability. Production processing of the semiconductor wafers takes place in a semiconductor fabrication facility. The semiconductor fabrication facility requires a large capital outlay for processing equipment, for the facility itself, and for a staff to run it. In order to recoup these expenses and generate a sufficient income from the facility, the processing equipment requires a throughput of a sufficient number of the wafers in a period of time. The processing equipment must also promote a reliable process in order to ensure continued revenue from the facility.

Until recently, the plasma ashing and the stripper bath were found sufficient for the removal of the photoresist and the photoresist residue in the semiconductor processing. However, recent advancements for the integrated circuits have made the plasma ashing and the stripper bath inadequate for highly advanced integrated circuits. These recent advancements include small critical dimensions of etched features and low dielectric constant materials for insulators. The small critical dimensions of the etched features are so small such that cleaning of the small dimension structures is extremely difficult. Many of the low dielectric constant materials cannot withstand an oxygen environment of the plasma ashing leading to a need for a replacement for the plasma ashing.

Recently, interest has developed in replacing the plasma ashing and the stripper bath for the removal of the photoresist and the photoresist residue with a supercritical process. However, high pressure processing chambers of existing supercritical processing systems are not appropriate to meet the unique needs of the semiconductor processing. In particular, high pressure chambers of existing supercritical processing systems do not provide a device for sufficiently securing the semiconductor wafer to a wafer platen. The methods for holding semiconductor wafers in position during processing are well known in the art. The physical environment to which the wafer is subjected is the largest determining factor as to which method to use to restrain the wafer during processing. The use of high pressure and high temperature carbon dioxide is fairly new to the semiconductor processing arena.

Vacuum has been used in many different semiconductor equipment types to hold the wafer to a wafer “chuck” for processing. In certain types of vacuum chucks, a vacuum groove is used to hold the semiconductor wafer to the semiconductor holding region. In these types of vacuum chucks, the underside of a semiconductor wafer has roughness that sufficient to allow leakage to occur between the underside of the wafer and the substantially smooth chuck surface. This leakage between the wafer and the chuck surface results in loss of the supercritical processing chemistry needed to process the wafer.

What is needed is a method and apparatus for holding the semiconductor wafer during the supercritical processing and providing a seal between the wafer and the wafer chuck to prohibit supercritical fluid from leaking through the underside of the wafer.

### SUMMARY OF THE INVENTION

One aspect of the invention is directed to a vacuum chuck for holding a semiconductor wafer during supercritical processing. The vacuum chuck comprises a semiconductor wafer holding region for holding the semiconductor wafer. The vacuum chuck includes a vacuum port for applying vacuum to a vacuum region in the surface of the semiconductor wafer. The vacuum chuck includes a material that is applied between the surface of the semiconductor wafer and the semiconductor holding region. The material is configurable to provide a uniform surface between the surface of the semiconductor wafer and the semiconductor holding region. The material absorbs at least one particulate matter between the semiconductor wafer and the wafer holding region. The vacuum chuck further includes a vacuum region, such as vacuum groove, coupled to the vacuum port, whereby vacuum is applied to the surface of the semiconductor wafer. The semiconductor holding region preferably has a smooth surface. In one aspect, the material comprises a coating including, but not limited to a polymer such as polyvinylidene fluoride. In another aspect, another material, such as a sintered material, is applied to the vacuum groove to provide a uniform surface underneath the wafer and thereby reduce stress on the semiconductor wafer caused by the vacuum and supercritical process pressures.

In another aspect of the invention, a vacuum chuck for holding a semiconductor wafer during high pressure processing. The vacuum chuck comprises a wafer platen which has a substantially smooth surface. The wafer platen also includes a semiconductor wafer holding region and a port that is operable to apply vacuum to a surface of the semiconductor wafer. The vacuum chuck also includes a coating which covers the smooth surface of the semiconductor wafer holding region. The coating is preferably polyvinylidene fluoride although any other appropriate material is suitable. The material absorbs at least one particulate matter between the semiconductor wafer and the wafer holding region. The vacuum chuck further comprises a vacuum region in the smooth surface, whereby the vacuum region may be a vacuum groove that is coupled to the port. The vacuum groove alternatively includes more than one circular vacuum groove, one of which is located proximate to and within an outer edge of the semiconductor holding region. Other vacuum grooves are alternatively located within a diameter of the first circular vacuum groove.

Another aspect of the invention is directed to a method of holding of a semiconductor wafer to a vacuum chuck during a supercritical process. The method comprises providing the vacuum chuck which has a semiconductor holding region. The method includes applying a material between a surface of the semiconductor wafer and the semiconductor holding region. The method also includes placing the semiconductor wafer to the semiconductor holding region such that the surface of the semiconductor wafer is mated with the semiconductor holding region. The method also includes applying a vacuum to the mating surface, whereby the material secures the semiconductor wafer to the semiconductor holding region by utilizing the vacuum. The material is preferably a polymer, monomer or any other suitable material having a predetermined thickness. The material absorbs at least one particulate matter between the semiconductor wafer and the wafer holding region.

### BRIEF DESCRIPTION OF THE DRAWINGS

FIG. 1A illustrates a perspective view of a vacuum chuck used with the method in accordance with the present invention.

FIG. 1B illustrates a cross sectional view of the vacuum chuck used in accordance with the method of the present invention.

FIG. 2 illustrates a cross sectional view of the vacuum chuck with a semiconductor wafer being held thereupon.

FIG. 3 illustrates a cross sectional view of the vacuum chuck with a semiconductor wafer being held thereupon in accordance with the preferred method of the present invention.

FIG. 4 illustrates a cross section of the vacuum chuck having the coating material and the sintered material applied thereto in accordance with the present invention.

FIG. 5 illustrates a cross section of the vacuum chuck having the coating material and the sintered material applied thereto in accordance with the present invention.

### DETAILED DESCRIPTION OF THE PREFERRED EMBODIMENT

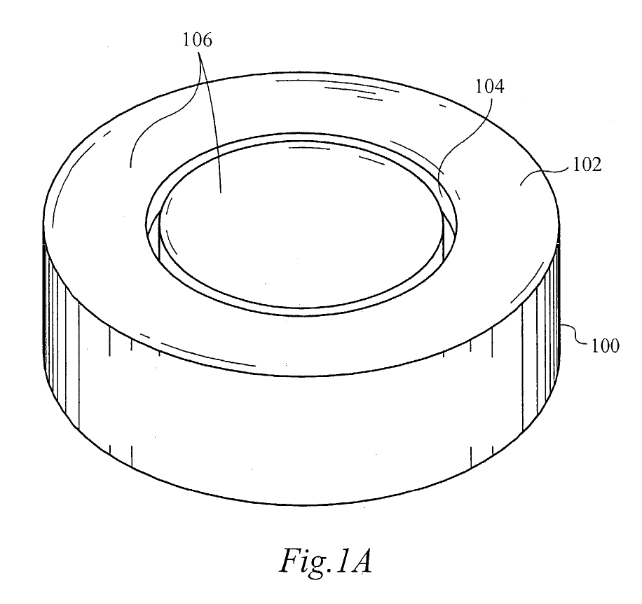

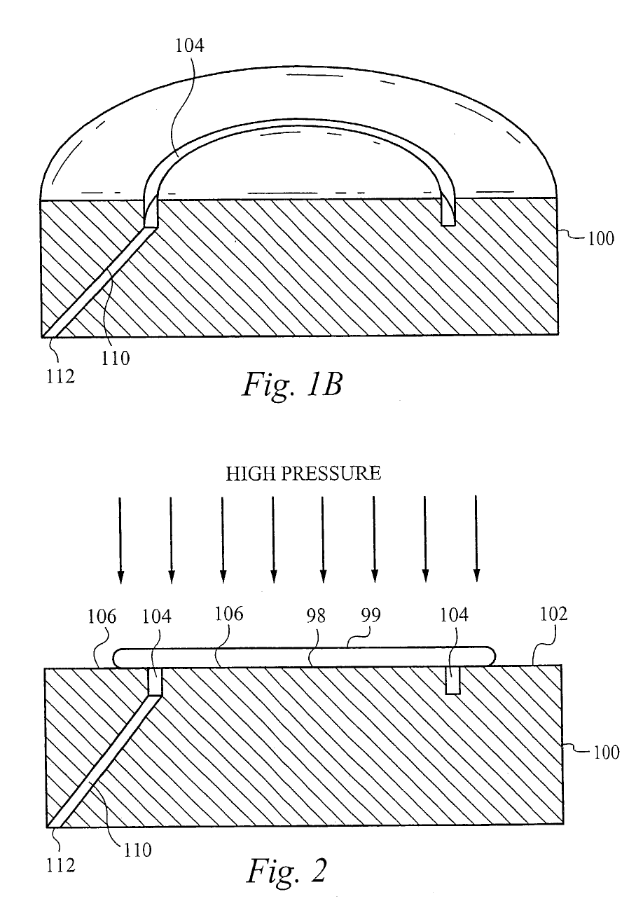

The preferred vacuum chuck of the present invention preferably holds a semiconductor wafer in a pressure chamber during high pressure processing. FIG. 1A illustrates a perspective view of a vacuum chuck 100 used with the supercritical processing methods in accordance with the present invention. The vacuum chuck 100 is shown having a circular configuration. Alternatively, the vacuum chuck 100 has other shaped configurations, including, but not limited to square or rectangular shapes. The vacuum chuck 100 is preferably a single piece, as shown in FIG. 1A. Alternatively, the vacuum chuck 100 is an assembly of several parts or part of a chamber wall (not shown). The vacuum chuck 100 includes a wafer platen 102 shown at the top surface of the chuck 100. The wafer platen 102 includes a vacuum region 104 and a semiconductor wafer holding region 106. The holding region 106 includes the area of the wafer platen 102 on top of which the semiconductor wafer (not shown) is placed. The holding region 106 is preferably substantially smooth and has an ultra-flat surface.

The vacuum region 104 in FIG. 1A is shown preferably as a circular groove 104, hereinafter referred to as a vacuum groove 104. Alternatively, the vacuum region 104 includes a vacuum hole (not shown). The vacuum groove 104 has a diameter which is smaller than the diameter of the semiconductor wafer which is being processed under the supercritical conditions. In addition, the vacuum groove 104 preferably has a minimum depth of 0.050 inch and a width range of 0.010-0.030 inches. Other dimensions of the vacuum groove 104 are contemplated, however. Alternatively, more than one vacuum groove is configured on the wafer platen 102, whereby the multiple vacuum grooves are concentrically formed from the center of the wafer platen 102. It should be noted, however, that the largest diameter vacuum groove 104 is equivalent to the outer diameter of the semiconductor wafer, such that the semiconductor wafer is sufficiently held on the wafer platen 102 and the force caused by the vacuum applied at the vacuum region 104 is not compromised.

FIG. 1B illustrates a cross sectional view of the vacuum chuck 100 in accordance with the present invention. A vacuum plenum 110 is shown in FIG. 1B, whereby the plenum 110 is coupled to the vacuum port 112 as well as the vacuum groove 104. A vacuum producing device (not shown) is coupled to the vacuum port 112. The vacuum producing device (not shown) produces a suction force that is applied from the vacuum port 112 via the vacuum plenum 110 to the bottom surface 98 of the wafer 99. The suction force applied via the vacuum plenum 110 to the bottom surface 98 of the wafer 99 aids in securing the wafer 99 to the holding region 106. Alternatively, multiple vacuum ports and lines are used and are coupled to the vacuum groove 104. Alternatively, small spider-web type features are created on the surface of the wafer platen for better distribution of the vacuum flow (not shown). For purposes of describing the present invention, the vacuum port 112, vacuum plenum 110 and vacuum groove 104 are considered to preferably be at less than atmospheric pressure and the wafer platen 102 of the vacuum chuck 100 are subjected to high pressure.

FIG. 2 illustrates a cross sectional view of the vacuum chuck 100 with a semiconductor wafer 99 being held thereupon. The semiconductor wafer 99 preferably has a diameter of 200 mm, although wafers having other diameters are contemplated. The semiconductor wafer 99 is placed upon the wafer platen 102, whereby a bottom surface 98 of the semiconductor wafer 98 is in contact with holding region 106 of the wafer platen 102. The vacuum groove 104 is shown in FIG. 2 as having a smaller diameter than the outer diameter of the semiconductor wafer 99. This allows vacuum applied to the wafer 99 through the vacuum groove 110 to apply a substantially uniform suction force to the bottom surface 98 of the semiconductor wafer 99 and thereby aid in holding the semiconductor wafer 99 to the platen 102. Also, as shown in FIG. 2, high pressure supercritical forces are applied to the wafer 99 from above which ensures that the wafer 99 is secured to the platen 102.

The bottom surface 98 of the semiconductor wafer 99 has sufficient roughness that a leak between the underside of the wafer 99 and the holding region 106 allows high pressure to pass through the vacuum groove 104 to the port 112. In other words, the surfaces of the semiconductor wafer 99 and the holding region 106, by themselves, do not provide a sufficient seal between the wafer 99 and the platen 102. In addition, the underside surface of the semiconductor wafer 99 mated with the smooth surface of the holding region 106 does not sufficiently form a tight seal between the wafer 99 and the holding region 106 of the vacuum chuck 100, despite the large pressure forces of the supercritical process and suction forces from the vacuum region 104.

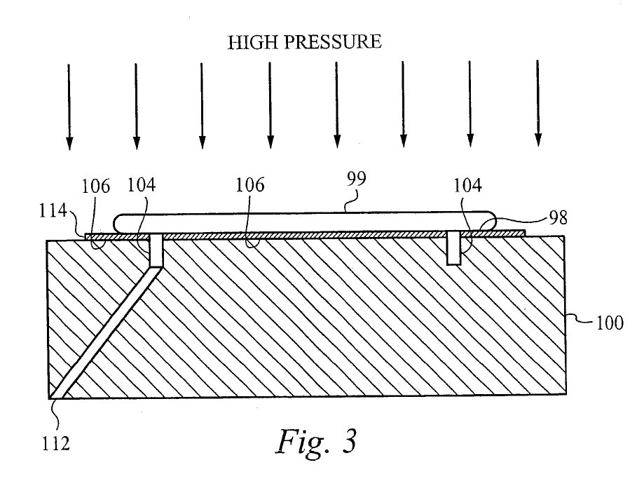

FIG. 3 illustrates a cross sectional view of the vacuum chuck 100 with a semiconductor wafer 99 being held thereupon in accordance with the present invention. As shown in FIG. 3, a thin layer of coating 114 is applied between the bottom surface 98 of the semiconductor wafer 99 and the holding region 106 of the vacuum chuck 100. The thin layer of coating 114 is preferably is applied to the surface of the holding region 106 of the vacuum chuck 100. Alternatively, the thin layer of coating 114 is applied to the entire surface of the wafer platen 102, including the holding region 106 and the vacuum region 104. Alternatively, the thin layer of coating 114 is applied to only coat the inner holding region 106, which is designated as the area of the wafer platen 102 inside of the diameter of the vacuum groove 104. Alternatively, the thin layer of coating 114 is applied to the bottom surface 98 of the semiconductor wafer 99, whereby the enhanced surface of the wafer 99 is placed onto the smooth surface of the vacuum chuck's 100 holding region 106.

The thin layer of coating 114 provides enough compliance with the bottom surface 98 of the wafer 99 to mold or conform to the microscopic irregularities that are present in the bottom surface 98 of the wafer 99. In effect, the intimate contact of the coating material 114 to the bottom surface of the wafer 99 forms a gas-tight seal between the wafer 99 and the wafer holding region 106. In other words, the seal provided by the coating material 114 preserves the integrity of the vacuum between the vacuum region 104 and the bottom surface 98 of the wafer. In addition, the seal provided by the material 114 prevents high pressure from the supercritical process to flow between the bottom surface 98 of the wafer and the vacuum groove 104. Thus, the coating 114 provides a substantially uniform seal between the bottom surface 98 of the wafer 99 and the holding region 106 of the chuck 100, such that the vacuum between the wafer 99 and the vacuum chuck 100 is not compromised. Further, the seal created by the coating 114 preserves the integrity of the supercritical processing chemistry by preventing any supercritical gases from escaping between the wafer 99 and the wafer holding region 106.

In addition, the soft, conforming characteristics of the coating 114 protects the wafer 99 from damage due to the presence of particulates between the underside 98 of the wafer 99 and the wafer holding region 106. Particulate matter between the underside 98 of the wafer 99 and the wafer holding region 106 may scratch the underside of the wafer 99 or even cause the wafer 99 to break under the high supercritical pressures. The soft conforming characteristics of the coating 114 allow the coating 114 to absorb the particulate matters under the high supercritical processing pressure. The absorption of the particulate matters within the coating 114 prevent the particulate matters from coming into contact with the underside 98 of the wafer 99.

The thin layer of coating material 114 applied between the bottom surface 98 of the wafer 99 and the holding region 106 preferably has a thickness in the range of 0.001 to 0.020 inches. However, the other thicknesses, which are larger or smaller than the preferred range, of the material are contemplated depending the type of material used. The thickness of the material 114 is sufficient to accomplish sealing of the wafer 99 with the holding region. In addition, the thickness of the material 114 is durable enough such that the material layer 114 has sufficient wear resistance. In addition, the layer of material 114 is preferably not too thick whereby the material 114 may deform or undergo cold flow due to the supercritical process pressure exerted upon the wafer 99. In addition, a thick layer of material 114 may cause cracks in the semiconductor wafer 99 due to the pressure involved in the supercritical process. The material 114 is preferably made of a polymer, such as polyvinylidene fluoride (KYNAR®). However, the material 114 alternatively is a monomer, paint, cellulose, any organic or inorganic substance or a combination thereof. As stated above, the material 114 is alternatively a monomer which has rubber-like characteristics, such as EPDM-90, whereby EPDM-90 provides a compliant surface for the bottom surface 98 of the wafer 99 to press against, such that the wafer 99 does not crack or break. It is apparent that the material 114 is made of any other appropriate materials having characteristics to provide an adequate seal between the wafer 99 and the holding region 106 or prevent breakage of the wafer 99 against the chuck 100.

The thin layer of material 114 applied to the wafer platen 102 is chemically resistant to all of the chemistries that are used in the supercritical process. In addition, the thin layer of material 114 preferably withstands the range of temperatures present in the supercritical process without the material's 114 properties degrading. Preferably the range of temperatures in which the material 114 is to operate is 40° C. to 90° C. However, as stated above, other materials may alternatively be used to provide the seal. Thus other temperature ranges, depending on the type of material utilized, are alternatively contemplated. In addition, the thin layer of material 114 preferably does not absorb any of the chemicals used in the supercritical process. However, the material 114 is preferably compatible with carbon dioxide, since carbon dioxide is primarily used in the supercritical processing method. Further, the material 114 preferably has an appropriate compressive modulus such that the material 114 is not affected by high pressures present in the supercritical processing method, preferably ranging between 1500 psi to 3000 psi. However, higher pressures are contemplated. The material 114 also preferably has an appropriate adhesion to allow the material 114 to remain on the wafer platen 102 after the semiconductor wafer 99 is removed. The process of applying the layer of material 114 to the vacuum chuck 100 is well known in the art and will not be discussed herein.

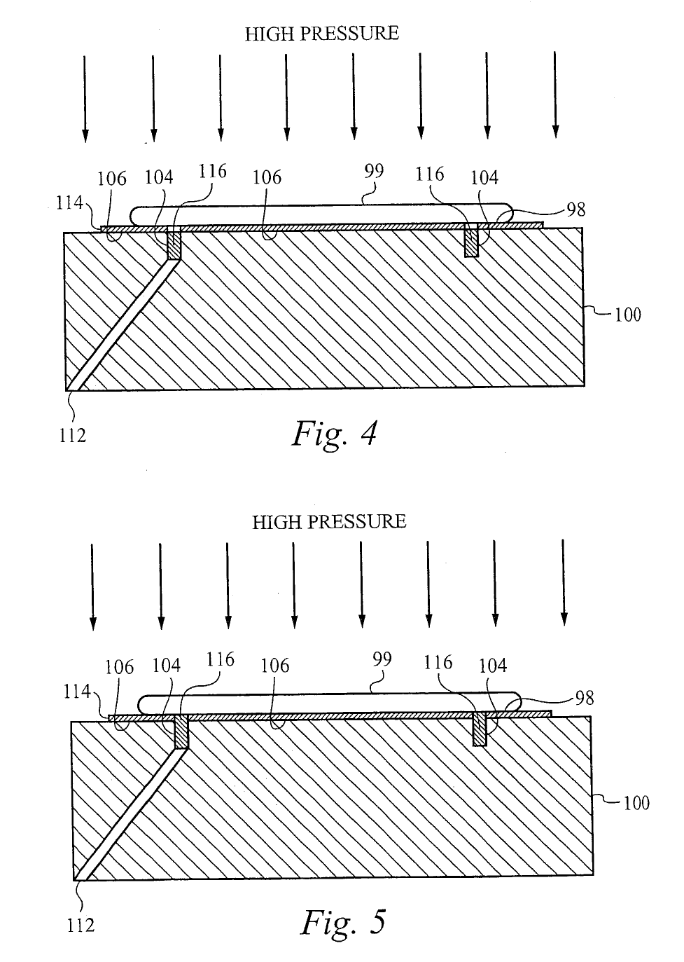

In an alternative embodiment, the vacuum chuck 100 of the present invention utilize both the material 114 and a sintered material 116 during supercritical processing of the wafer 99. FIG. 4 illustrates a cross section of the vacuum chuck 100 having the material 114 as well as the sintered material 116 between the wafer 99 and the wafer platen 102. As shown in FIG. 4, the thin layer of the material 114 is applied to the holding region 106. In addition, the sintered material 116 is applied to the vacuum region 104. Specifically, the sintered material 116 is applied within the vacuum groove 104 until the channel within the vacuum groove 104 is filled with the sintered material 116 and forms a surface uniform with the top or mating surface of the holding region 106. Alternatively, an appropriate additional amount of sintered material 116 is applied to the vacuum region 104 to provide a surface uniform with the surface of the material 114. The sintered material has porous characteristics to allow a sufficient amount of vacuum to be applied to the bottom surface of the wafer 99 while providing support to the bottom surface of the wafer 99. In effect, the sintered material allows the vacuum to hold the wafer 99 to the holding region 106 and prevents the wafer 99 from cracking or breaking due to the supercritical forces applied to the wafer 99. It should be noted that in this alternative embodiment, the thin layer of material 114 is not applied to the vacuum region 104 due to the presence of the sintered material 116. Alternatively, the coating and sintered material 116, individually or in combination, are applied to the bottom surface 98 of the wafer 99, as discussed above. The details of the sintered material are described in co-pending U.S. patent application Ser. No. ______ filed on ______ and entitled, “VACUUM CHUCK UTILIZING SINTERED MATERIAL AND METHOD OF PROVIDING THEREOF” which is hereby incorporated by reference. It should be noted, that although FIG. 4 illustrates the material 114 being utilize with the sintered material 116 within the vacuum groove 104, the material 114 may alternatively be used with a vacuum chuck having a sintered surface on which the wafer 99 is placed.

Once the coating 114 and sintered material 116 are applied to the vacuum chuck, the semiconductor 99 is mated with the material 114 along the mating surface. As discussed above, the material 114 molds to the irregularities present in the bottom surface 98 of the wafer 99 and thereby creates a seal which holds and secures the wafer 99 to the vacuum chuck 100. In addition, the sintered material 116 provides a flat surface with the holding region 106 (FIG. 4), or alternatively the material 114 (FIG. 5), whereby the sintered material 116 fills the channel of the vacuum groove 104 and creates a uniform surface across the vacuum groove 104. This uniform surface across the vacuum groove 104 provides support to the bottom surface of the wafer 99 at the areas where the vacuum groove 104 is located. In addition, the porous density of the sintered material 116 allows vacuum to be applied to the bottom surface of the wafer 99 through the vacuum groove 104 and does not cause excessive stresses to the wafer 99. Further, the support provided underneath the wafer 99 by utilizing the sintered material 116 prevents the wafer 99 from cracking or breaking from the high pressure forces from the supercritical process.

It will be readily apparent to one skilled in the art that other various modifications may be made to the preferred embodiment without departing from the spirit and scope of the invention as defined by the appended claims.

We claim:

1. A vacuum chuck for holding a semiconductor wafer during supercritical processing comprising:
a. a wafer holding region for holding the semiconductor wafer;
b. a vacuum port for applying vacuum to a portion of the wafer holding region; and
c. a material applied between the semiconductor wafer and the wafer holding region, the material being conformable to provide substantially intimate contact between the surface of the semiconductor wafer and the wafer holding region.

2. The vacuum chuck of claim 1 wherein the wafer holding region comprises a substantially smooth surface.

3. The vacuum chuck of claim 2 wherein the material comprises a polymer applied in a layer of predetermined thickness.

4. The vacuum chuck of claim 2 wherein the material comprises a monomer applied in a layer of predetermined thickness.

5. The vacuum chuck of claim 1 further comprising a vacuum region configured within the wafer holding region, wherein the vacuum region is coupled to the vacuum port.

6. The vacuum chuck of claim 1 wherein the material absorbs at least one particulate matter between the semiconductor wafer and the wafer holding region.

7. The vacuum chuck of claim 1 wherein the material provides a seal between the wafer holding region and the semiconductor wafer.

8. A vacuum chuck for holding a semiconductor wafer during high pressure processing comprising:
a. a wafer platen having a substantially smooth surface, the substantially smooth surface having a wafer holding region and a port operable to apply vacuum to a surface of the semiconductor wafer in the wafer holding region; and
b. a coating layer positioned between the substantially smooth surface of the wafer holding region and the semiconductor wafer, wherein the coating layer provides a seal between the wafer holding region and the semiconductor wafer.

9. The vacuum chuck of claim 8 further comprising a vacuum region in the smooth surface.

10. The vacuum chuck of claim 9 wherein the vacuum region further comprises a vacuum groove coupled to the port.

11. The vacuum chuck of claim 10 wherein the vacuum groove comprises a first circular vacuum groove.

12. The vacuum chuck of claim 11 wherein the first circular vacuum groove is located proximate to and within an outer edge of the wafer holding region.

13. The vacuum chuck of claim 12 the smooth surface further comprises a second circular vacuum groove located within a diameter of the first circular vacuum groove.

14. The vacuum chuck of claim 8 wherein the coating layer further comprises a polymer applied in a layer of predetermined thickness.

15. The vacuum chuck of claim 8 wherein the coating layer further comprises a monomer applied in a layer of predetermined thickness.

16. The vacuum chuck of claim 8 wherein the coating layer is conformable to provide substantially intimate contact between the surface of the semiconductor wafer and the wafer holding region.

17. The vacuum chuck of claim 8 wherein the coating layer absorbs at least one particulate matter between the semiconductor wafer and the wafer holding region.

18. A method of holding of a semiconductor wafer to a vacuum chuck during a supercritical process comprising:
a. providing the vacuum chuck having a wafer holding region;
b. applying a material along an interface between the semiconductor wafer and the wafer holding region, the material configurable to provide substantially intimate contact between the semiconductor wafer and the wafer holding region; and
c. positioning the semiconductor wafer on the wafer holding region along the interface, wherein the material creates a seal at the interface.

19. The method of holding according to claim 18 applying a vacuum to the interface, wherein the material secures the semiconductor wafer to the semiconductor holding region.

20. The method of holding according to claim 16 wherein the material further comprises a polymer, wherein the polymer is applied in a predetermined thickness.

21. The method of holding according to claim 18 wherein the material further comprises a polymer applied in a layer of predetermined thickness.

22. The method of holding according to claim 18 wherein the material absorbs at least one particulate matter between the semiconductor wafer and the wafer holding region.
